(19) United States
(12) Patent Application Publication
(10) Pub. No.: US 2026/0006137 A1
(43) Pub. Date: Jan. 1, 2026

(54) INFORMATION PROCESSING APPARATUS AND DISPLAY METHOD

(71) Applicant: SHARP KABUSHIKI KAISHA, Sakai City (JP)

(72) Inventor: Kenji OGASAWARA, Sakai City (JP)

(21) Appl. No.: 19/245,864

(22) Filed: Jun. 23, 2025

(30) Foreign Application Priority Data
Jun. 27, 2024 (JP) 2024-104247

(51) Int. Cl. H04N 1/00

(52) U.S. Cl. CPC H04N 1/00514; H04N 1/00424; H04N 1/00506; H04N 2201/0094

(57) ABSTRACT

An information processing apparatus includes: a display that displays one or more user displays corresponding to one or more users on a display screen; a processor that executes processing for logging in, among the one or more users, as a user corresponding to a user display selected from the one or more user displays; and one or more controllers that perform control for displaying the one or more user displays, each at a predetermined display position fixed on the display screen.

### CROSS-REFERENCE TO RELATED APPLICATION

The present application claims priority from Japanese Application JP2024-104247, the content of which is hereby incorporated by reference into this application.

### BACKGROUND OF THE INVENTION

### 1. Field of the Invention

The disclosure relates to an information processing apparatus and a display method.

### 2. Description of the Related Art

As illustrated in the related art, for example, there is known an image forming apparatus that searches for user information based on both users who performs login by selecting a user icon displayed on a display and users who performs login according to communication with a card, and then executes login processing of the identified user.

### SUMMARY

An object according to an aspect of the disclosure is to provide an information processing apparatus and a display method that facilitate intuitive selection of a desired user display from among user displays associated with each user and a reduction in login errors caused by mistaken selection of a user display, for example.

An information processing apparatus according to an aspect of the disclosure includes a display that displays one or more user displays corresponding to one or more users on a display screen, a processor that executes processing for logging in, among the one or more users, as a user corresponding to a user display selected from the one or more user displays, and one or more controllers that perform control for displaying the one or more user displays, each at a predetermined display position fixed on the display screen.

A display method according to an aspect of the disclosure includes displaying one or more user displays corresponding to one or more users on a display screen, executing processing for logging in, among the one or more users, as a user corresponding to a user display selected from the one or more user displays, and performing control for displaying the one or more user displays, each at a predetermined display position fixed on the display screen.

According to an aspect of the disclosure, it is possible to provide an information processing apparatus and a display method that facilitate intuitive selection of a desired user display from among user displays associated with each user and a reduction in login errors caused by mistaken selection of a user display.

### BRIEF DESCRIPTION OF THE DRAWINGS

FIG. 1 is a diagram for describing an overall configuration of a first embodiment.

FIG. 2 is a diagram for describing a hardware configuration of an image forming apparatus according to the first embodiment.

FIG. 3 is a diagram for describing a software configuration of the image forming apparatus according to the first embodiment.

FIG. 4 is a diagram for describing an example of user information according to the first embodiment.

FIG. 5 is a diagram for describing a flow of processing according to the first embodiment.

FIG. 6 is a diagram for describing a flow of login screen display processing according to the first embodiment.

FIG. 7 is a diagram for describing a flow of user management processing according to the first embodiment.

FIG. 8 is a diagram for describing an operation example according to the first embodiment.

FIG. 9A and FIG. 9B are diagrams for describing an operation example according to the first embodiment.

FIG. 10A and FIG. 10B are diagrams for describing an operation example according to the first embodiment.

FIG. 11A and FIG. 11B are diagrams for describing an operation example according to the first embodiment.

FIG. 12A and FIG. 12B are diagrams for describing an operation example according to the first embodiment.

FIG. 13 is a diagram for describing the flow of the user management processing according to a second embodiment.

FIG. 14 is a diagram for describing an operation example according to the second embodiment.

FIG. 15 is a diagram for describing the flow of the user management processing according to a third embodiment.

FIG. 16A and FIG. 16B are diagrams for describing an operation example according to the third embodiment.

### DETAILED DESCRIPTION OF THE INVENTION

In a case in which, for example, a user utilizes an information processing apparatus or receives various services through an information processing apparatus, the user can utilize the information processing apparatus by performing a login process. Here, when logging in to the information processing apparatus, the user needs to log in to the information processing apparatus by inputting, for example, a user ID and a password, perform various processing on an acquired image, and output the image.

An information processing apparatus can be included in various devices. Here, for example, in a case in which an image forming apparatus such as a multifunction peripheral/printer/product (MFP) is provided with an information processing apparatus, there is known a login method (referred to as quick login in the disclosure) in which a user can easily perform login by selecting an icon.

A user registers for quick login by assigning an icon to himself/herself. For specifications in which, during user registration, the user both registers user information and selects an icon, the possibility exists that the icon overlaps that of another user. When the same icon as that of another user is used, the user often determines and selects his/her own user display using the icon during login, and thus may erroneously select the icon of the other user and attempt login as the other user. When, in response, a control is implemented so that already selected icons are not displayed during user registration, icon overlap with another user does not occur. However, this results in a problem in that some users find the operation of selecting an icon itself to be bothersome.

An information processing apparatus for solving such problems will be described below in embodiments with reference to the drawings. Note that the disclosure set forth in the claims will be described in the embodiments below as an example, and the technical scope of the disclosure is not limited to the following description.

### 1. FIRST EMBODIMENT

Hereinafter, a first embodiment will be described. Note that the first embodiment will be described using the following as an example. In the following embodiment, a case will be described in which an information processing apparatus of the disclosure is applied to an image forming apparatus. However, the information processing apparatus of the disclosure may be applied to an apparatus other than an image forming apparatus.

### 1.1 Overall Configuration

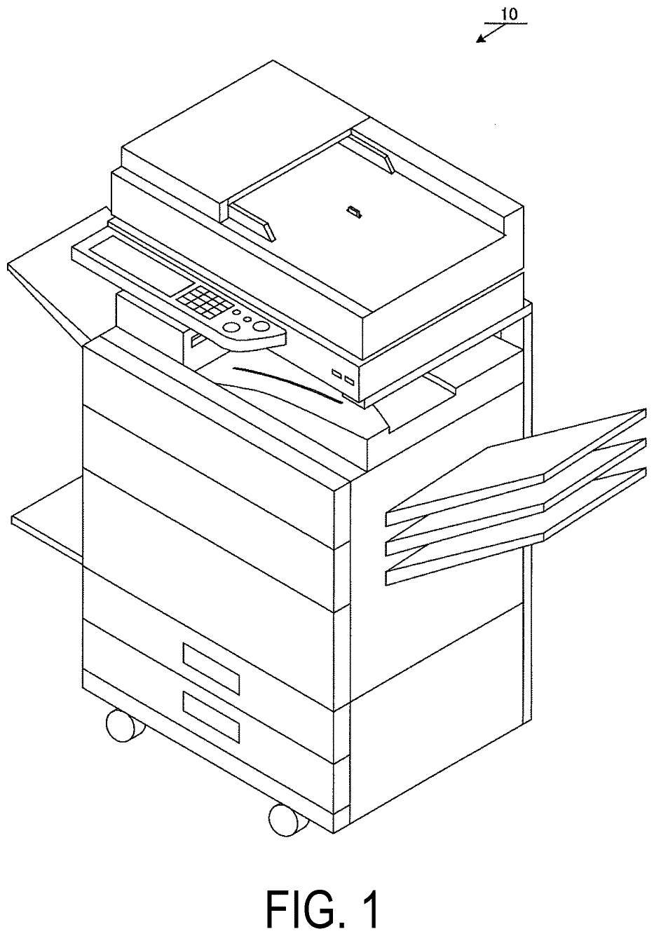

FIG. 1 is a perspective view illustrating an overall configuration of an image forming apparatus 10.

The image forming apparatus 10 is, for example, a multifunction peripheral or an apparatus called an MFP. For example, when executing a job (print job), the image forming apparatus 10 can form an image on a sheet that is a recording medium. The image forming apparatus 10 can execute a job for a plurality of processing operations such as copy processing, facsimile (FAX) processing, scan processing, and print processing, as a job to be executed.

A network (NW) connecting the image forming apparatus 10 may be any communication line or communication system and may utilize a local area network (LAN) that utilizes wired or wireless technology, a virtual local area network (VLAN), the Internet, or a public line network, or a communication system such as mobile communication (mobile communication such as 4G/5G/6G, for example) or a next-generation telephone network, for example.

### 1.2 Hardware Configuration

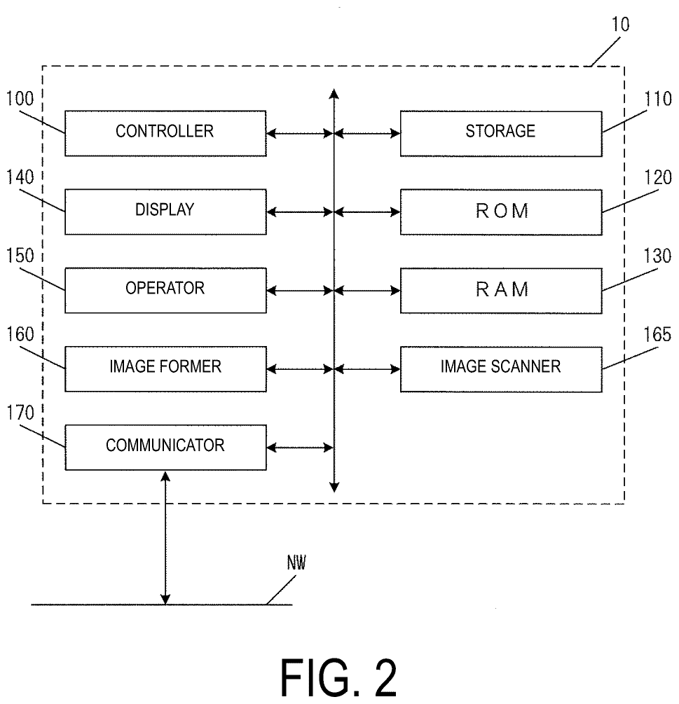

A hardware configuration of the image forming apparatus 10 will be described below with reference to the drawings. FIG. 2 is a diagram illustrating an example of the hardware configuration of the image forming apparatus 10.

As illustrated in FIG. 2, the image forming apparatus 10 includes a controller 100, a storage 110, a read only memory (ROM) 120, a random access memory (RAM) 130, a display 140, an operator 150, an image former 160, an image scanner 165, and a communicator 170. The storage 110, the ROM 120, and the RAM 130 serve as storage devices (storages).

The controller 100 controls the image forming apparatus 10 as a whole. The controller 100 implements various functions by reading and executing various programs stored in the storage devices (storage 110 and ROM 120, for example). The controller 100 may be implemented by one or more control devices/arithmetic devices (central processing unit (CPU) or system on a chip (SoC)). The controller 100 may include one or more control circuits.

The storage 110 is a non-volatile storage device capable of storing programs and data. For example, the storage 110 may include one or more storage devices such as a hard disk drive (HDD) or a solid state drive (SSD). The storage 110 may be configured as an external device such as a universal serial bus (USB) memory that can be connected to the image forming apparatus 10. The storage 110 may be, for example, a storage area on a cloud.

The ROM 120 is a non-volatile memory capable of holding the programs and data even if the power is turned off.

The RAM 130 is a main memory mainly utilized when the controller 100 executes processing. The RAM 130 is a rewritable memory that temporarily holds a program read from the storage 110 or the ROM 120 and data including an execution result.

The display 140 is a display device that can display various types of information and various screens such as an execution screen. The display 140 may be, for example, a display device such as a liquid crystal display (LCD), an organic electro-luminescence (EL) display, or an electrophoresis display. The display 140 includes an interface to which the display device can be connected. For example, the display 140 may include an external display device connected via a high-definition multimedia interface (HDMI; trade name), a digital visual interface (DVI), or a display port.

The operator 150 is an operation device that allows a user to input an operation. For example, the operator 150 may be software keys displayed on a touch panel integrated with the display 140 or hardware keys such as operation buttons. The operator 150 may be an operation device such as a keyboard or a mouse, for example. The operator 150 may also include an interface (USB, for example) to which an operation device can be connected. For example, the image forming apparatus 10 may be connected to different operation devices (keyboard, mouse, and the like) via an interface.

The image former 160 forms an image on, for example, a recording sheet. The image former 160 includes, for example, an image carrier, and forms an image by forming a toner image on the image carrier and transferring the toner image on the image carrier onto the recording sheet. The image former 160 may be configured as the image forming apparatus 10 serving as a printer or the like. The image former 160 may electronically form an image as an image file.

The image scanner 165 scans a document (image) and outputs the document as image data. The image scanner 165 is, for example, a scanner, and may be a scanning device that utilizes a charge coupled device (CCD), a contact image sensor (CIS), or a complementary metal-oxide-semiconductor (CMOS) image sensor.

The communicator 170 is a communication interface that communicates with other devices. The communicator 170 may be, for example, a network interface capable of providing wired connection or wireless connection. In the present embodiment, communication with other devices is available via a network (NW).

### 1.3 Software Configuration

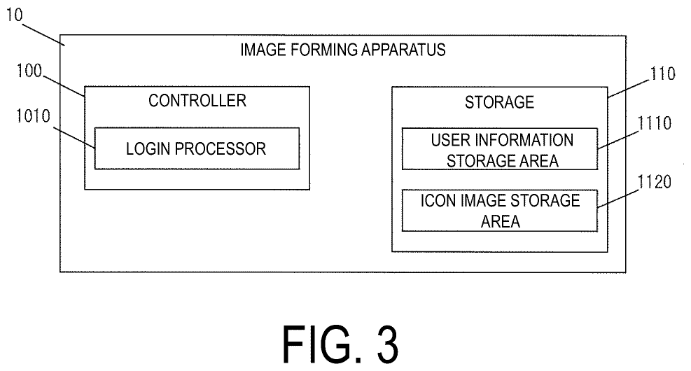

A main software configuration of the image forming apparatus 10 will be described with reference to FIG. 3. Note that, in the software configuration illustrated in FIG. 3, configurations necessary for the present embodiment are mainly described, and other configurations are omitted.

For example, the controller 100 can implement a login processor 1010 by reading and executing programs stored in the storages (storage 110, ROM 120).

The login processor 1010 executes login processing and authentication of a user. For example, by logging in to the image forming apparatus 10, a login-authorized user capable of login can execute the various processing of the image forming apparatus 10. Processing in which a user logs in or logs out of the image forming apparatus 10 is referred to as login processing.

The login processor 1010 realizes a normal login function (hereinafter “normal login function”) and a quick login function according to the present embodiment (hereinafter “quick login function”) when executing the login processing.

Here, the normal login function is a function in which a user inputs a login name, a password, and the like to log in to the image forming apparatus 10. On the other hand, the quick login function is, for example, a function in which a user selects a user display displayed in a list on the display 140 to log in to the image forming apparatus 10. Here, the user display refers to a display that displays at least an identification image (icon image) such as an icon that specifies a user, and may include a login name (user name).

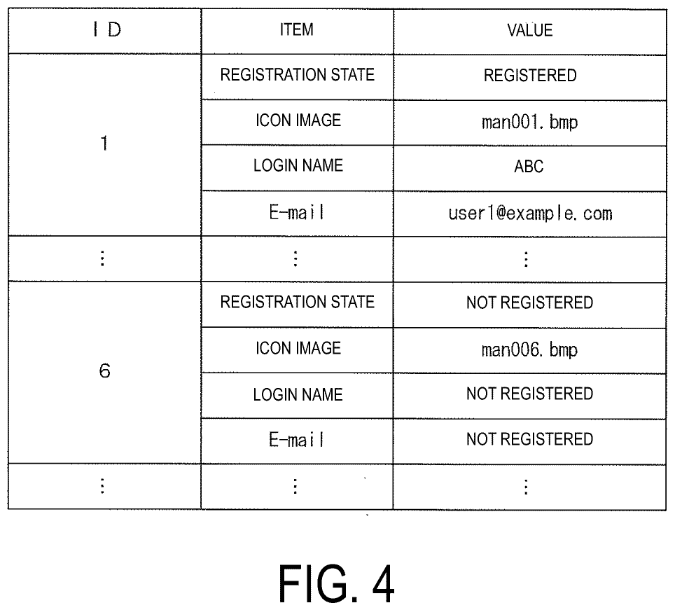

The storage 110 secures a user information storage area 1110 for storing user information. The user information is, for example, information for a user to log in to the image forming apparatus 10. Here, an example of the user information stored in the user information storage area 1110 will be described with reference to FIG. 4. The user information storage area 1110 stores an identification (ID; “1,” for example) of a position (registration position) in a display of user displays displayed by the image forming apparatus 10 on the display 140, an item (“registration state,” for example) corresponding to the ID, and a value (“registered,” for example) corresponding to the item.

The user information may include information related to the display of the user display (login name and icon image, for example), information necessary for login (password, for example), and additional information (e-mail, identification number, and affiliation, for example). Note that, in the user information, an ID and at least one or more unique icon images, for example, are stored in association with each other.

The storage 110 secures an icon image storage area 1120 for storing icon images. The icon image storage area 1120 stores the icon images for identifying the user displays. The icon image is, for example, an image file such as BMP, PNG, GIF, or JPG, but may also include characters such as character text or symbols, as necessary. The icon images may be stored in advance or may be created by the users.

### 1.4 Processing Flow

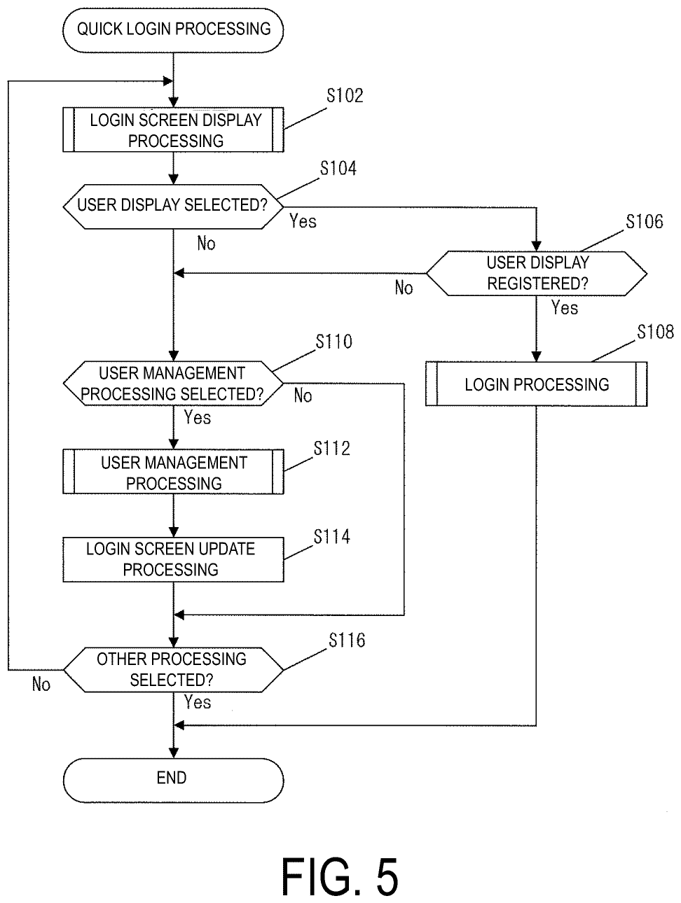

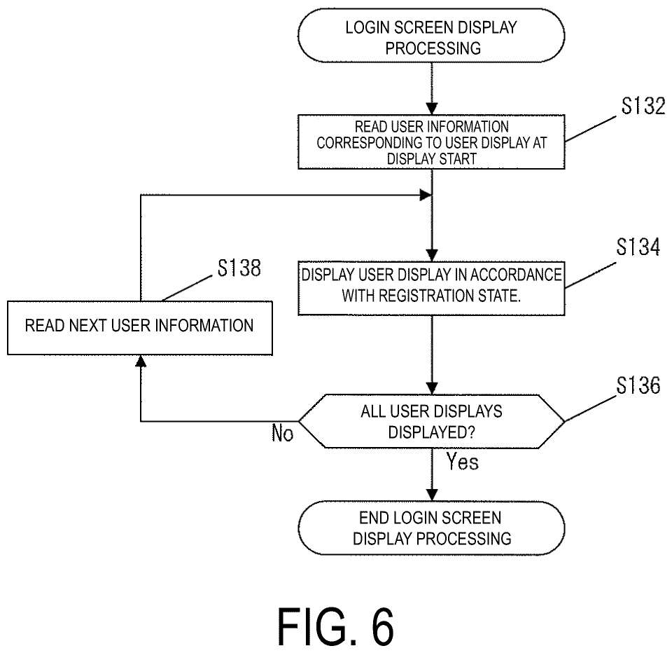

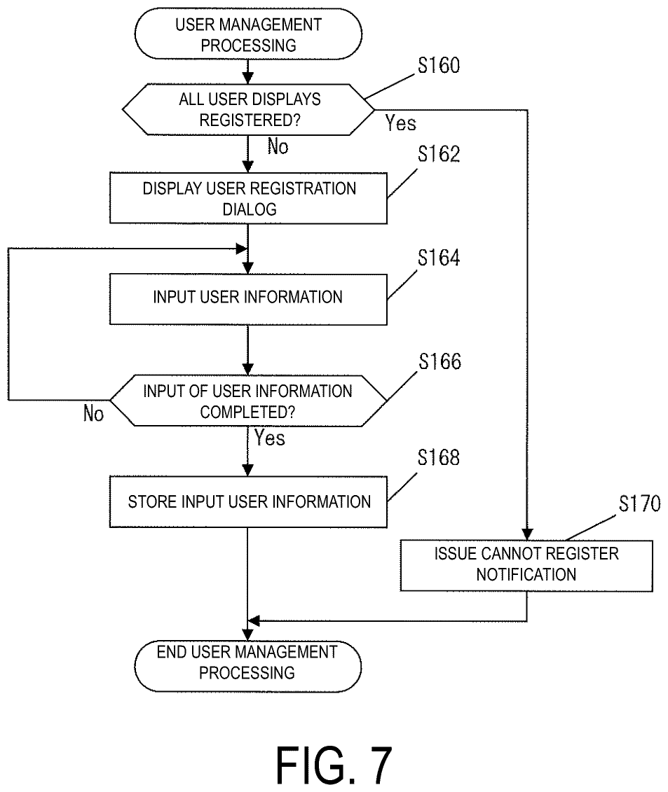

Hereinafter, a processing flow according to the present embodiment will be described with reference to FIG. 5, FIG. 6, and FIG. 7. FIG. 5, FIG. 6, and FIG. 7 are diagrams illustrating the processing flow of the present embodiment. Note that the configuration described with reference to FIG. 2 or FIG. 3 may execute the processing of each step.

### 1.4.1 Quick Login Processing

FIG. 5 is a diagram illustrating a quick login processing flow of the present embodiment. First, the controller 100 executes, for example, login screen display processing for displaying a quick login screen as a display screen on the display 140 (S102).

Next, the controller 100 determines whether a user display on the quick login screen is selected (S104). In a case in which the determination is made that a user display is selected, the controller 100 determines whether the user display is registered (S104; Yes→S106). Next, in a case in which the user display is registered, the controller 100 executes the login processing (S106; Yes→S108).

In a case in which a determination is made that a user display is not selected (S104; No) or in a case in which the user display is not registered (S106; No), the controller 100 determines whether user management processing is selected (S110). In a case in which the user management processing is selected by the user, the user management processing is executed (S110; Yes→S112). Here, the user management processing may include processing for newly registering a user, processing for removing a registered user, and processing for changing a location (registration position) of a user display after registration.

Subsequently, the controller 100 executes update processing of the quick login screen and reflects a display state of the user display registered or removed by the user management processing (S114).

In a case in which the determination is made that the user management processing is not selected, the controller 100 determines whether processing other than the processing described above is selected (S110; No→S116). In a case in which processing other than the processing described above is selected, the quick login processing is ended (S116; Yes). When other processing is not selected, the controller 100 repeatedly executes the quick login processing (S116; No→S102).

Note that the above-described operation flow is an example, and partially different processing may be performed. In the present embodiment, processing for switching a plurality of quick login screens may be executed between S102 and S104, for example.

### 1.4.2 Login Screen Display Processing

FIG. 6 is a diagram illustrating a flow of the login screen display processing of the present embodiment. First, the controller 100 reads the user information corresponding to a user display at display start (S132). Here, the user display at the display start is the user display first displayed on the quick login screen. For example, in a case in which first to eighth user displays are displayed on the quick login screen, the first user display is the user display at the display start.

For example, in a case in which up to eight user displays can be displayed on the quick login screen, the controller 100 displays the first to the eighth user displays. Thus, the controller 100 can display a list of user displays on the quick login screen starting from the user display at the display start.

Here, positions of the user displays are preferably fixed on the quick login screen. That is, in a case in which the first to the eighth user displays are displayed on the quick login screen, the user displays are displayed in the order of ID, and the unique icon images associated with different icon image types and IDs are displayed at fixed positions (registration positions). That is, the icon types are set in the order in which they are registered or in advance in accordance with the registration position of each button (user display; at fixed predetermined display positions). Accordingly, the user can intuitively find the user display preferably used for login from the display position (registration position) of the user display including the icon image, and perform the login processing.

Subsequently, the controller 100 displays the user display on the quick login screen according to the registration state of the user information (S134).

Here, as a method of displaying the user display in accordance with the registration state of the user information, the following methods are conceivable. As a first method, in a case in which the user information is registered, the user display including, for example, the icon image and the login name is displayed and, in a case in which the user information is not registered, the user display including only the icon image is displayed. As a second method, in a case in which the user information is not registered, the user display displaying the icon image and “Not registered” as the login name is displayed, for example. As a third method, in a case in which the user information is not registered (icon image for user information not registered), a user display such as an icon image in a display mode different from that in a case in which the user information is registered is displayed, such as, for example, an icon image displayed faintly transparent (at a light density) by differentiating the display density from that when the user information is registered, an icon image having the same pattern but a different color, an icon image different from that when user information is registered, or an icon image displaying a sub-icon image.

Next, the controller 100 determines whether all user displays are displayed, that is, whether the eighth user display is displayed if eight user displays can be displayed on the quick login screen, for example (S136). In a case in which all user displays are not displayed, the controller 100 reads the next user information (S136; No→S138). On the other hand, in a case in which all user displays are displayed, the controller 100 ends the login screen display processing (S136; Yes).

### 1.4.3 User Management Processing

FIG. 7 is a diagram for describing a flow of the user management processing according to the present embodiment. Note that, herein, processing for registering a user will be described as an example of the user management processing.

First, the controller 100 determines whether all user displays are registered (S160). Next, in a case in which a non-registered user display exists, the controller 100 displays a dialog allowing input of user information as a display screen for user registration (user registration screen) (S160; No→S162). Note that, although a dialog is displayed in the present embodiment, a display screen, for example, may be displayed on the display 140 instead of the dialog. Further, for example, the controller 100 selects an ID of user information that is in a non-registered state as the registration target in a predetermined order, and the user registration screen displays the ID including the icon image corresponding to the ID. Here, in a pattern in which a location is not selected by the user, the controller 100 preferably selects and registers the ID of the registration target in order starting from the beginning (top left) of the IDs in a non-registered state, for example.

Next, the controller 100 receives input of the user information from the user (S164). Subsequently, the controller 100 determines whether the input of the user information is completed and, in a case in which the determination is made that the input of the user information is completed, stores the user information input by the user in ID order or in the ID corresponding to the icon image displayed by step S162, for example (S166; Yes→S168). In a case in which the input of the user information is not completed, the controller 100 repeatedly executes the input of the user information (S166; No→S164).

Note that in a case in which the determination is made that all user displays are registered, the controller 100 provides a notification indicating that a user display cannot be registered (S160; Yes→S170).

### 1.5 Operation Examples

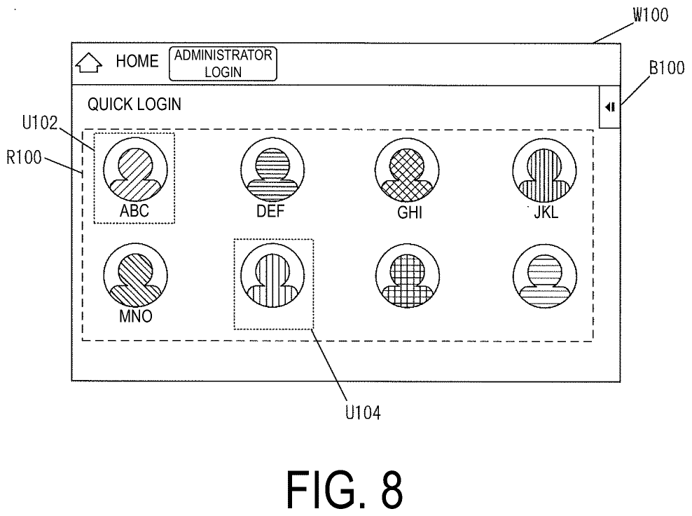

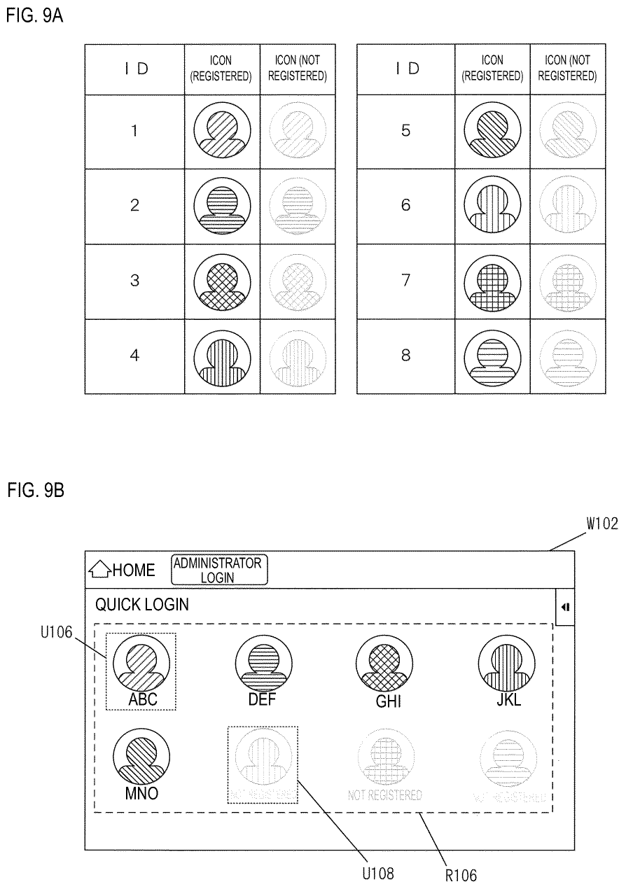

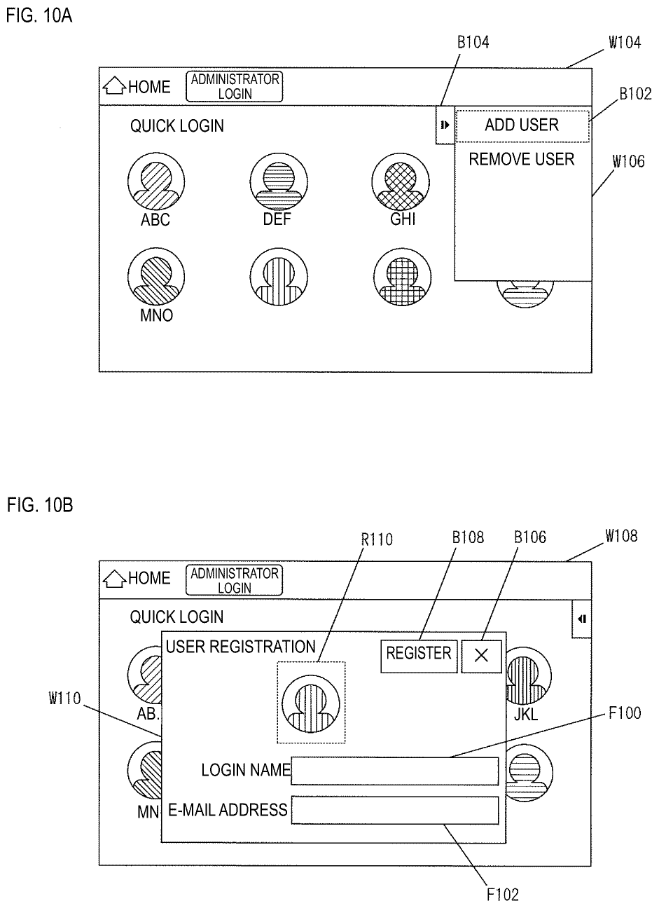

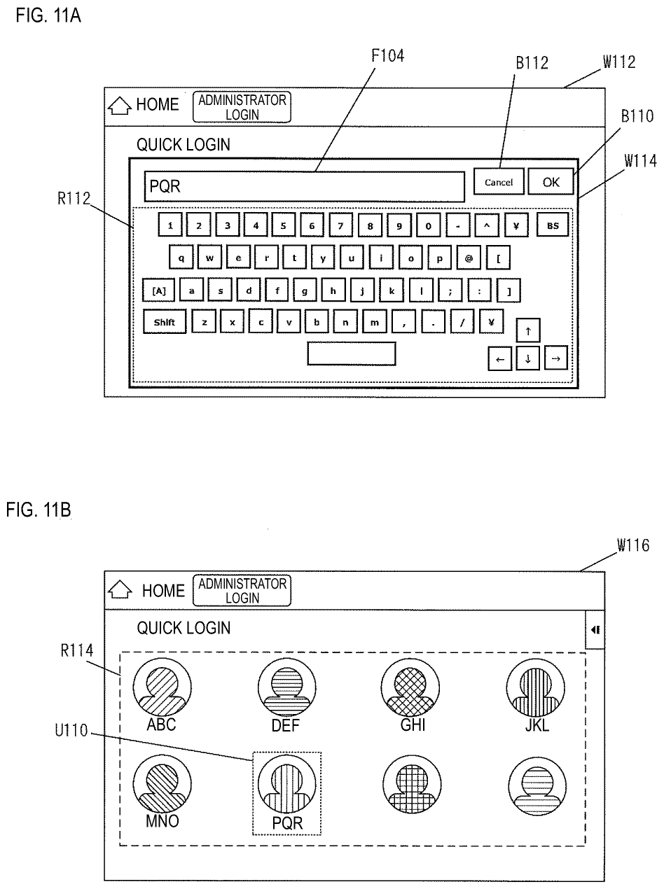

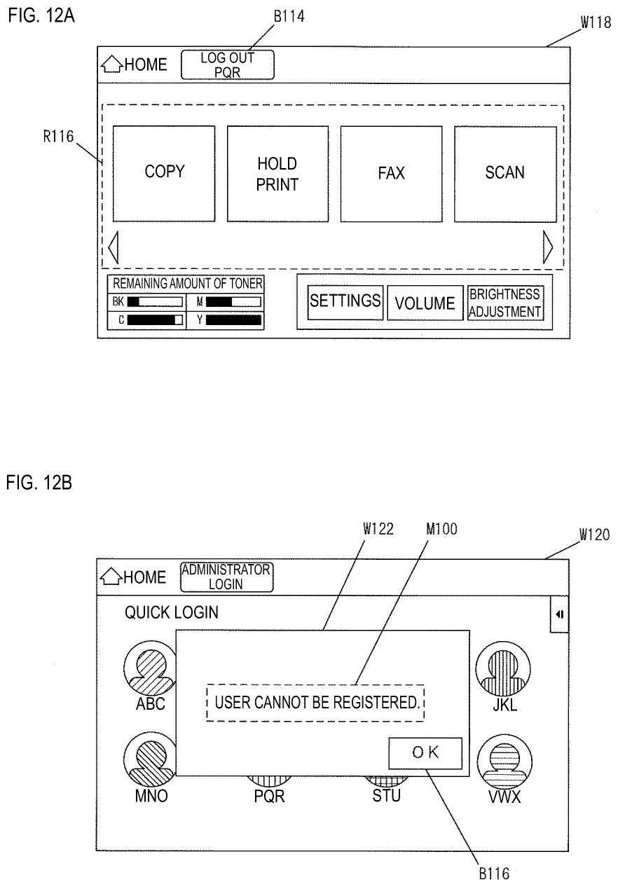

FIG. 8, FIG. 9A and FIG. 9B, FIG. 10A and FIG. 10B, FIG. 11A and FIG. 11B, and FIG. 12A and FIG. 12B are diagrams illustrating examples of display screens including a message displayed to the user as an operation result of the image forming apparatus 10 according to the present embodiment.

FIG. 8 is a diagram illustrating an example of a display screen W100 displayed on the display 140 of the image forming apparatus 10, and illustrates an example of the quick login screen (display screen) including a message displayed to the user in a case in which the user logs in to the image forming apparatus 10 by the quick login function, for example. A button B100 and a list display area R100 of user displays are displayed on the display screen W100.

In the list display area R100 of the user displays, the user displays are listed in order from the upper left according to ID, for example. In the present embodiment, up to eight user displays can be registered, and five are currently registered. However, the number registrable is not limited thereto, and may be eight per screen with the ninth and subsequent users registrable on second and subsequent screens. In a case in which the ID of the user display at the display start is “1,” a user display U102 that is registered and corresponds to the ID “1” and a user display U104 that is not registered and corresponds to the ID “6” are included and listed in the list display area R100 of the user displays, for example. Here, the icon image associated with the user information having the ID “1” and the user name are displayed in the user display U102, and the icon image associated with the user information having the ID “6” is displayed and a user name is not displayed in the user display U104. That is, when the user information associated with the user display displayed at a predetermined display position is registered, the user name is displayed together with the icon image.

Here, when the user selects the registered user display U102, the controller 100 executes the login processing and displays, for example, a display screen W118 of FIG. 12A with the login user name displayed on a button B114 as “ABC.” On the other hand, when the user selects the non-registered user display U104, the controller 100 does not execute the login processing. At this time, the user may be notified that the operation on the non-registered user display U104 is invalid by playing an input invalid sound or the like. When the user selects (taps) the button B100, the controller 100 displays a display screen W104 and a window display (action panel) W106 of FIG. 10A. Thus, the controller 100 displays the ID, the registration position, and the type of icon (image) in association with each other, making the type of user icon different for each icon registration position and facilitating a reduction in mistaken selection of a user display (user icon) during login.

FIG. 9A is a diagram illustrating examples of the icon images used for the user displays in the present embodiment. FIG. 9A illustrates the IDs and unique icon images corresponding to the IDs. Here, the registered icon images and the non-registered icon images are registered in association with the IDs.

FIG. 9B is a diagram illustrating an example of a display screen (quick login screen) W102 having a pattern different from that of the display screen W100 of FIG. 8 and using the icon images illustrated in FIG. 9A. In an area R106 of the display screen W102, a user display U106 that is registered and a user display U108 that is not registered are displayed. Here, in the user display U106, the registered icon image corresponding to the ID “1” is displayed as illustrated in FIG. 9A. On the other hand, in the user display U108, the non-registered icon image corresponding to the ID “6” illustrated in FIG. 9A is displayed. Thus, the icon images corresponding to each registration position are displayed at a light density or the like before registration, making it possible to recognize the non-registered state.

FIG. 10A is a diagram illustrating an example of the display screen W104 displayed on the display 140 of the image forming apparatus 10, and the window display (action panel) W106 displayed overlapping the display screen W104. In the window display W106, an add user button B102 and a button B104 are displayed. Note that, although the add user button B102 and the remove user button are separately provided in the window display W106, only one button may be displayed as an add/edit user button, for example. When the user selects (taps, for example) the add user button B102, the controller 100 displays (activates) a display screen (user registration dialog) W108 in FIG. 10B. On the other hand, when the user selects the button B104, the controller 100 displays the display screen W100 of FIG. 8 or the display screen W102 of FIG. 9B, for example.

FIG. 10B is a diagram illustrating an example of the display screen W108 displayed on the display 140 of the image forming apparatus 10, and a window display W110 displayed overlapping the display screen W108. The window display W110 displayed overlapping the display screen W108 displays a display area R110 of an icon image, a login name (user name) input form F100, an e-mail address input form F102, a register button B108, and a (cancel) button B106. The login name input form F100 and the e-mail address input form F102 are displayed with blank values. Here, as the icon image displayed in the display area R110 of the icon image, the controller 100 selects an ID of the registration target in order from the top (upper left) of the IDs for which user information is not registered, and displays the icon image corresponding to the selected ID, for example. Note that, as patterns different from those of the display screen W108, the controller 100 may, for example, further display a password input form and a password (confirmation) input form, or may display only the login name input form F100, in the window display W110 displayed overlapping the display screen W108. In a case in which input of the login name is mandatory, a message to that effect may be displayed.

Here, when the user inputs values into the login name input form F100 and the e-mail address input form F102 and selects (taps) the register button B108, the controller 100 stores the input user information in the user information corresponding to the selected ID and displays a display screen W116 of FIG. 11B. On the other hand, when the user selects the (cancel) button B106, the display screen W100 of FIG. 8 is displayed, for example.

FIG. 11A is a diagram illustrating an example of a display screen W112 displayed on the display 140 of the image forming apparatus 10, and a window display W114 displayed overlapping the display screen W112. For example, FIG. 11A is a diagram illustrating an example of an input screen displayed in a case in which the user selects the login name input form F100 or the e-mail address input form F102 on the display screen W108 of FIG. 10B. The window display W114 displayed overlapping the display screen (input screen) W112 displays a software keyboard area R112, the input form F104, an OK button B110, and a cancel button B112.

For example, in a case in which the user selects the login name input form F100 in FIG. 10B, the user inputs the login name in the input form F104 in FIG. 11A. Next, when the user selects the OK button B110, the controller 100 reflects the login name input in the input form F104 in the login name input form F100 in FIG. 10B and displays the display screen W108 of FIG. 10B. On the other hand, when the user selects the cancel button B112, the controller 100 displays the display screen W108 of FIG. 10B in a blank state without reflecting the input in the login name input form F100 of FIG. 10B.

FIG. 11B is a diagram illustrating an example of the display screen W116 displayed on the display 140 of the image forming apparatus 10. In the list display area R114 of the user displays of the display screen W116, a user display U110 newly registered is added to the non-registered users that are open on the quick login screen (top-left justified) and displayed as a new user. Here, when the user selects the user display U110, the controller 100 executes the login processing and displays, for example, the display screen W118 of FIG. 12A. In this way, the user icons may be configured to only be registrable in a predetermined order (from the beginning of the IDs in non-registered states).

FIG. 12A is a diagram illustrating an example of the display screen W118 displayed on the display 140 as a home screen of the image forming apparatus 10. A log out button B114 is displayed on the display screen W118. Note that, in addition to the button name (log out), the login name of the user logged in (currently logged in), for example, may be displayed or may not be displayed on the log out button B114. In an area R116 of the display screen W118, an operation menu (functional buttons) for executing various jobs is displayed. Here, when the user selects the log out button B114, the display screen W116 of FIG. 11B may be displayed, or the display screen W100 of FIG. 8 may be displayed, for example.

FIG. 12B is a diagram illustrating an example of a display screen W120 displayed on the display 140 of the image forming apparatus 10 by the controller 100 in a case in which all user displays are registered and, for example, the user selects the add user button B102 in FIG. 10A. On the display screen W120, a window display W122 displayed overlapping the display screen W120 is displayed. In the window display W122, a message M100, “User cannot be registered,” and an OK button B116 are displayed. Here, when the user selects the OK button B116, the controller 100 closes the window display W122 and displays the quick login screen on which all registered user displays are displayed.

### 1.6 Effects

Thus, according to the present embodiment, during quick login user registration, unique icons are assigned in the order of user registration without displaying an icon selection screen. That is, the icon is always unique, making it possible to reduce mistaken login by a user caused by mistaken selection of an icon. Furthermore, during user registration, the step involving the icon selection screen is omitted and icon registration (selection) on the quick login user registration screen is not required, resulting in a decrease in complexity in operation.

Further, the user icon type for the login user is fixed relative to the registration position of the icon (user display), making it possible for the user to intuitively select the user display from a correspondence relationship between the registration position of the user display and the icon image.

### 2. SECOND EMBODIMENT

Hereinafter, a second embodiment will be described. The second embodiment is, for example, an embodiment in which, during user information registration, the user displays without user information registered are highlighted, and user information can be registered in association with a user display displayed in a fixed manner at a registration position and selected as desired by the user from among open non-registered locations (registration positions of user displays without registered user information).

In the second embodiment, the same hardware and software configurations as those of the first embodiment will not be described, and differences from the first embodiment will be mainly described.

### 2.1 Processing Flow

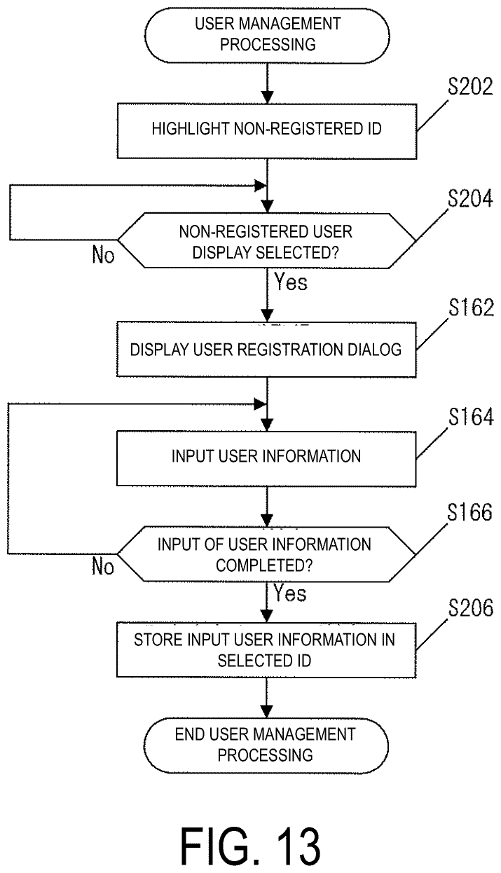

Hereinafter, a processing flow according to the present embodiment will be described with reference to FIG. 13. FIG. 13 is a diagram for describing a flow of user registration processing according to the present embodiment. FIG. 13 replaces FIG. 7 of the first embodiment. S202 and S204 are executed before S162 in FIG. 7, and S206 is executed instead of S168.

First, the controller 100 highlights the user displays (non-registered user displays) corresponding to the IDs for which user information is not registered (S202). Here, as a method of highlighting the user displays, methods such as the following are conceivable. As a first method, the user displays (registered user displays) other than the non-registered user displays are transparently displayed. As a second method, the icon images of the non-registered user displays are displayed in a different display color. As a third method, the registered user displays are grayed out.

Next, the controller 100 receives selection of a user display from the user, and determines whether a non-registered user display is selected (S204). The controller 100 continues to determine whether a non-registered user display is selected until a non-registered user display is selected (S204; No→S204). When a non-registered user display is selected, the controller 100 displays a dialog for user registration (S204; Yes→S162).

In a case in which the input of the user information is completed, the controller 100 stores the input user information in the ID of the non-registered user display selected in step S204 (S166; Yes→S206).

### 2.2 Operation Example

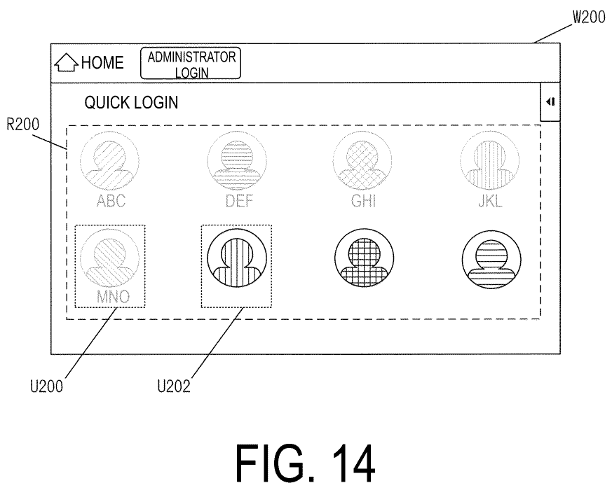

FIG. 14 is a diagram illustrating an example of a display screen W200 displayed as an operation result of the image forming apparatus 10 according to the present embodiment in a case in which the add user button B102 is selected on the display screen W104 of FIG. 10A, for example. In an area R200 of the display screen W200, a user display U200 that is registered and a user display U202 that is not registered are displayed in list format. The registered user display U200 is transparently displayed, and the non-registered user display U202 in a non-registered open location is highlighted. Here, when the user selects (taps) the user display U202, the controller 100 displays (activates) the display screen W108 of FIG. 10B as a user registration dialog. Thus, registered users are displayed lightly (in light displays), icons and characters of non-registered users are displayed normally (darker than the icons of registered users), and a user can register user information in association with a user display displayed in a fixed manner at a desired registration position among those of the non-registered users.

### 2.3 Effects

The controller 100 highlights user displays for which user information is not registered, making it easy for the user to select a non-registered user display and eliminating mistaken selection of registered user displays. During user registration, the user selects a registration position, making it possible for the user to freely register information at a position that is personally easy to remember and operate.

### 3. THIRD EMBODIMENT

Hereinafter, a third embodiment will be described. The third embodiment is an embodiment of, for example, a pattern that also enables selection of a location of a registered user display when user information management processing is executed, making it possible to register a user in a case in which user information is not registered and update user information (edit a user) in a case in which a registered user is selected.

In the third embodiment, the same hardware and software configurations as those of the first embodiment and the second embodiment will not be described, and differences from the first embodiment and the second embodiment will be mainly described.

### 3.1 Processing Flow

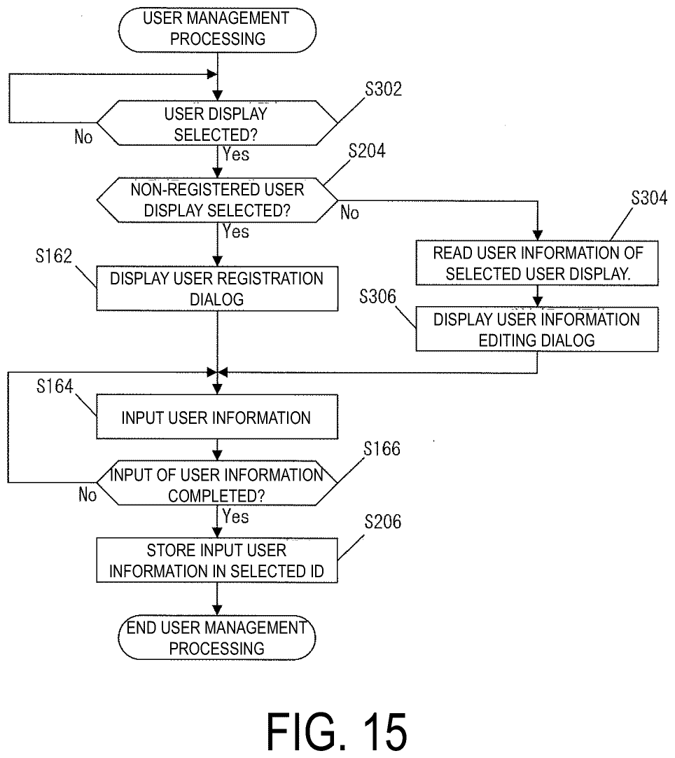

Hereinafter, a processing flow according to the present embodiment will be described with reference to FIG. 15. FIG. 15 is a diagram for describing a flow of the user registration processing according to the present embodiment. FIG. 15 replaces FIG. 13 of the second embodiment. S302 is executed instead of S202 in FIG. 13, and S304 and S306 are executed after S204.

First, the controller 100 continues to determine whether a user display is selected until a user display is selected (S302; No→S302). In a case in which the determination is made that a user display is selected, the controller 100 determines whether a non-registered user display is selected (S302; Yes→S204). Subsequently, in a case in which the determination is made that a registered user display is selected, the controller 100 reads the user information corresponding to the selected registered user display (S204; No→S304). Subsequently, the controller 100 displays a dialog allowing editing of the read user information (S306).

### 3.2 Operation Examples

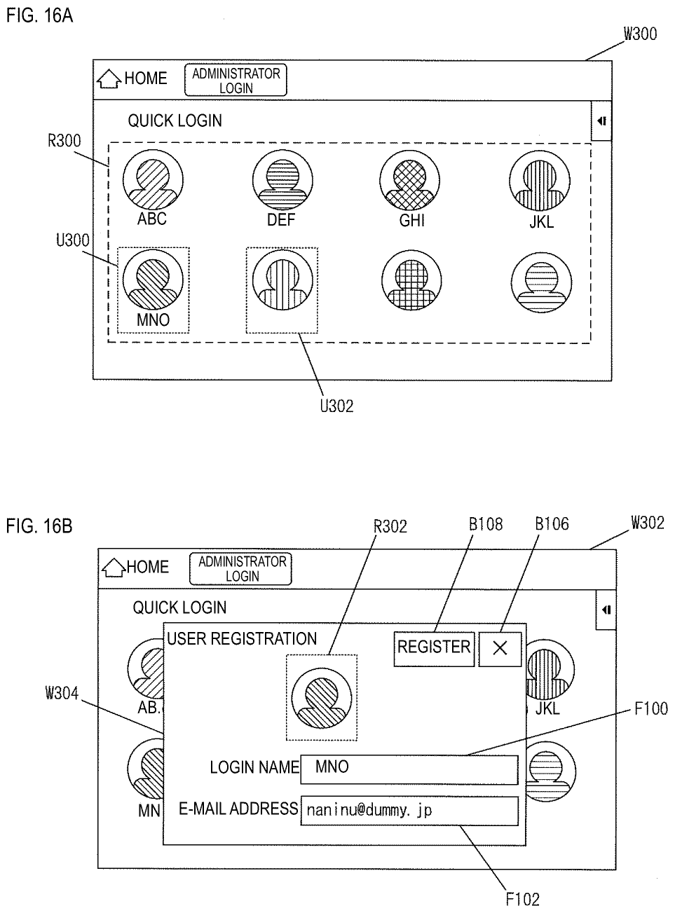

FIG. 16A is a diagram illustrating an example of a display screen W300 displayed as an operation result of the image forming apparatus 10 according to the present embodiment in a case in which the add user button B102 is selected on the display screen W104 of FIG. 10A, for example. In an area R300 of the display screen W300, a user display U300 that is registered and a user display U302 that is not registered are displayed in list format. Here, when the user selects (taps) the user display U300 from the list display, the controller 100 displays a display screen W302 of FIG. 16B. On the other hand, when the user selects (taps) the user display U302 from the list display, the controller 100 displays the display screen W108 of FIG. 10B. Thus, normal display is performed for both user displays of registered users and user displays of non-registered users, and whether an edit user dialog or a register user dialog is displayed is determined in accordance with the user display selected.

FIG. 16B is a diagram illustrating an example of the display screen W302 displayed on the display 140 of the image forming apparatus 10, and a window display (edit user dialog) W304 displayed overlapping the display screen W302. In the window display W304, the icon image display area R302, the login name input form F100, the e-mail address input form F102, the register button B108, and the (cancel) button B106 are displayed.

Here, the icon image displayed in the icon image display area R302 is an icon image corresponding to the registered user display U300 selected by the user in FIG. 16A and cannot be edited. The controller 100 similarly inputs and displays, in the login name input form F100 and the e-mail address input form F102, the values stored in the user information in correspondence with the registered user display U300. When the user inputs (edits a registered user in) at least one of the login name input form F100 or the e-mail address input form F102 and selects (taps) the register button B108, the controller 100 stores (updates) the input user information in the user information corresponding to the ID of the user display U300 and displays, for example, the display screen W116 of FIG. 11B. On the other hand, when the user selects the (cancel) button B106, the display screen W100 of FIG. 8 is displayed, for example.

Note that, in the present embodiment, neither a registered user display nor a non-registered user display are highlighted. Here, for example, the controller 100 may perform highlighting by respectively changing the display colors of the registered user display and the non-registered user display or by displaying a sub-icon image or the like.

### 3.3 Effects

In addition to user display registration, the controller 100 facilitates the editing of a user display. During user display editing as well, selection errors at the time of selection of the user display to be edited can be reduced, making it possible to reduce the time and effort required for user operations and thus reduce complexity in operation.

### 4. VARIATIONS

The disclosure is not limited to the above-described embodiments, and various modifications are possible.

In other words, embodiments obtained by combining technical mechanisms appropriately changed without departing from the gist of the disclosure are also included in the technical scope.

In the above-described embodiments, the image forming apparatus has been described as an example of the information processing apparatus. However, the disclosure is also applicable to other information processing apparatuses. For example, an example of the information processing apparatus may be a smartphone or a tablet. The information processing apparatus may be a home appliance (for example, an air conditioner, a refrigerator, or a television) equipped with an Internet of Things (IoT) function. The information processing apparatus is not limited to a stationary apparatus, and may be a portable apparatus or an in-vehicle apparatus, for example. For example, the in-vehicle apparatus may be an apparatus such as a car navigation system.

Although the above-described embodiments have been separately described for convenience of description, the embodiments can be combined and executed within an allowable range. The right of any of the technologies described herein is intended to be acquired through amendment, divisional application, or the like.

The programs running on each device in the embodiments are programs for controlling a CPU or the like (programs for causing a computer to function) to implement the aforementioned functions in the embodiments. Information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM or a non-volatile memory card), an optical recording medium or a magneto-optical recording medium (for example, a digital versatile disc (DVD), a compact disc (CD), or a Blu-ray (trade name) disc (BD)), a magnetic recording medium (for example, a magnetic tape or a flexible disk), and the like.

Further, when distributed in the market, the program can be stored in a portable recording medium and distributed, or can be transferred to a server computer connected via a network such as the Internet. In this case, it is a matter of course that the storage device of the server device is also included in the disclosure.

Instead of being stored in the device, the above-described data may be stored in an external device and called as appropriate. For example, the data may be stored in a network attached storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case in which . . . ” and “when . . . ” are described as examples, and the configuration is not limited to the described contents. Configurations not indicated by the descriptions “in a case in which . . . ” and “when . . . ” are also disclosed to the extent that the configurations are obvious to a person skilled in the art, and the rights thereof are intended to be acquired.

The processing and the flow of data have been described herein with order, but the order thereof is not limited to the described order. For example, a configuration in which processing is partly removed or the order is rearranged is also disclosed, and the right thereof is intended to be acquired.

Although the functions described in the embodiments are described as being performed in the respective devices, the functions may be implemented in one device or by using an external server.

In addition, each functional block or various features of the device used in the above-described embodiments may be implemented or executed by an electric circuit such as, for example, an integrated circuit or a plurality of integrated circuits. An electrical circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof.

The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing apparatus comprising:
a display that displays one or more user displays corresponding to one or more users on a display screen;
a processor that executes processing for logging in, among the one or more users, as a user corresponding to a user display selected from the one or more user displays; and
one or more controllers that perform control for displaying the one or more user displays, each at a predetermined display position fixed on the display screen.

2. The information processing apparatus according to claim 1,
wherein the one or more user displays are respectively associated with corresponding icon images, and
the one or more controllers display the corresponding icon images, the corresponding icon images being different types in accordance with the display position.

3. The information processing apparatus according to claim 2,
wherein user information of the one or more users can be respectively registered in association with the one or more user displays, and
the one or more controllers display the corresponding icon images at the display positions even for, among the one or more user displays, a user display for which the user information is not registered.

4. The information processing apparatus according to claim 3,
wherein the one or more controllers display the corresponding icon images associated with the user displays for which the user information is not registered and the corresponding icon images associated with the user displays for which the user information is registered in display modes that differ from each other.

5. The information processing apparatus according to claim 4,
wherein the one or more controllers differentiate the display modes by differentiating display densities of the corresponding icon images, or display colors of the corresponding icon images.

6. The information processing apparatus according to claim 3,
wherein, when respectively registering the user information in association with the one or more user displays, the one or more controllers register the user information according to a predetermined display order of the one or more user displays displayed on the display screen, or the one or more users each select a desired display position among the display positions of the one or more user displays displayed on the display screen.

7. A display method comprising:
displaying one or more user displays corresponding to one or more users on a display screen;
executing processing for logging in, among the one or more users, as a user corresponding to a user display selected from the one or more user displays; and
performing control for displaying the one or more user displays, each at a predetermined display position fixed on the display screen.
